(19) United States
(12) Patent Application Publication
(10) Pub. No.: US 2025/0181819 A1
(43) Pub. Date: Jun. 5, 2025

(54) RESCALING TEXT BLOCKS TO IMPROVE READABILITY

(71) Applicant: MYSCRIPT, Nantes Cedex 3 (FR)

(72) Inventors: Nicolas RUCINE, Nantes Cedex 3 (FR); Thibault DESCHAMPS, Nantes Cedex 3 (FR)

(21) Appl. No.: 18/846,081

(22) PCT Filed: Mar. 10, 2023
(86) PCT No.: PCT/EP2023/056252

§ 371 Date: Sep. 11, 2024

(30) Foreign Application Priority Data
Mar. 11, 2022 (EP) 22161627.9

(51) Int. Cl. G06F 40/109; G06F 40/106

(52) U.S. Cl. CPC G06F 40/109; G06F 40/106

(57) ABSTRACT

Methods and devices (DV) for rescaling text blocks to maintain readability are disclosed. In a display area (5) an initial text block enclosed in an initial container including a block handle is displayed. In an input area, a user interaction gesture over the block handle is detected. The initial container height is resized according to the user interaction gesture. An updated interline ratio is determined in response to said resizing. An updated font size is determined in response to said determining of the updated interline ratio. Finally, an updated text block including the updated interline ratio and the updated font size according to the resized container is displayed.

### FIELD OF THE INVENTION

The present disclosure relates generally to the field of computing device interfaces capable of interacting with and editing text blocks. In particular, the present disclosure relates to the management of resizing text blocks and adjusting their typeset typography to improve readability of the text.

### BACKGROUND

Computing devices continue to become more ubiquitous to daily life. They take the form of computer desktops, laptop computers, tablet computers, hybrid computers (2-in-1 s), e-book readers, mobile phones, smartphones, wearable computers, global positioning system (GPS) units, enterprise digital assistants (EDAs), personal digital assistants (PDAs), game consoles, and the like. Further, computing devices are being incorporated into vehicles and equipment, such as cars, trucks, farm equipment, manufacturing equipment, building environment control (e.g., lighting, HVAC), and home and commercial appliances.

Computing devices generally consist of at least one processing element, such as a central processing unit (CPU), some form of memory, and input and output devices. The variety of computing devices and their subsequent uses necessitate a variety of interfaces and input devices. One such input device is a touch sensitive surface such as a touch screen or touch pad wherein user input is received through contact between the user's finger or an instrument such as a pen or stylus and the touch sensitive surface. Another input device is an input interface that senses gestures made by a user above the input interface. A further input device is a position detection system which detects the relative position of either touch or non-touch interactions with a non-touch physical or virtual surface. Any of these methods of input can be used generally for drawing or inputting text. The user's handwriting is interpreted using a handwriting recognition system or method.

One application of handwriting recognition in non-portable computing devices, such as in-vehicle control and entertainment systems, and in portable computing devices, such as smartphones, phablets and tablets, is for the input of text into various applications run by the computing devices in a manner similar to that traditionally done with keyboard, either physical or virtual, and voice.

Available handwritten note-taking applications generally provide users with the ability to typeset the handwritten input either manually or automatically (e.g., on-the-fly). However, as typeset text is generally smaller and more uniform than handwritten text, the user's layout of the handwritten input, such as in sentences and paragraphs, may not translate well to typeset text, e.g., the visual size of the sentences becomes too small such that the paragraphs lose their visual meaning. This loss of visual meaning may result in particular from the inherent physical limitations of users, such as the limited capacities of human eyes, which are not well adapted to read and understand relatively small sized sentences.

This can be overcome by reflowing the typeset text so that the layout appears to be preserved, e.g., paragraphs are retained. However, the user's original handwritten layout may be meaningful and the typesetting of the handwritten text may not take into account the spacing and distribution of the lines. Also, any further interaction of the user for preserving the original handwritten layout of the typeset text may lead to loss of optimal legibility and altered readability of the text content. Legibility may refer to the visual clarity of typeset text related to the ability to distinguish one letter from the other. Readability may refer to a measure of how easy it is to read a piece of text.

More generally, the ability in conventional text management applications to display text, such as typeset text or handwritten text, is limited. Certain operations for arranging the text may be available, but they often involve complex or unnatural manipulations by the users. As such, it is often difficult for users to visualize text content in an ergonomic and efficient manner. These limitations and deficiencies result in particular from the fact that the user interface and the associated user manipulations are usually not (or poorly) adapted to the ergonomics, anatomy or physical constraints of the users.

### SUMMARY OF THE INVENTION

Resizing of object blocks and images may be performed using handles displayed around a selected block or container. Access to the handles, with corresponding display of the block boundaries, may be provided by the present system and method in a natural and well understood manner to users, such as by the user simply performing a single tap on the content to be resized/edited. As is understood by those skilled in the art, once displayed, users touch or hover over the handles and drag/push the selected handle across the interface so as to provide different behaviors with dragging/pushing of corner handles causing scaling of the block (moves two sides, thus keeping the bounding box aspect ratio) and dragging/pushing of side handles causing stretching of the bounding box (move single side, thus changing bounding box aspect ratio). In conventional systems, changing the bounding box aspect ratio has no impact on the inner image aspect ratio, rather the image is automatically scaled/centered.

Other types of non-text blocks and text blocks can be explicitly resized in the same manner. However, when a paragraph is resized, the font size of the text content is usually not changed (i.e., scaled), only the paragraph's dimensions. Typically, since a text block height is usually defined by the inner content of the text block, only a block width variation can modify the paragraph layout in conventional systems.

Therefore, it has been observed that user interaction with text block height may be advantageous to allow rescaling text blocks and their content in a more interactive fashion.

The examples of the present invention that are described herein below provide a computing device, methods and corresponding computer programs for rescaling an initial text block, said initial text block containing text arranged in multiple lines according to an initial font size of and an initial interline ratio.

According to a first aspect, the invention provides a method for rescaling an initial text block to maintain readability, said initial text block containing text arranged in multiple lines, having a same interline distance between any consecutive lines, according to an initial font size and an initial interline ratio, said initial interline ratio determined as a function of the initial font size and the interline distance, said method comprising: displaying, in a display area of the computing device, the initial text block enclosed in an initial container having an initial container height, said initial container, said initial text block including a block handle; detecting, in an input area, a user interaction gesture over the block handle; resizing the initial container height into a resized container height according to the user interaction gesture, resulting in an updated interline distance; determining an updated interline ratio of said text in response to said resizing; determining an updated font size of said text in response to said determining of the updated interline ratio; and displaying an updated text block having the resized container height, said updated text block, said updated text block including the updated interline ratio and the updated font size.

According to a particular embodiment, the text contained in the initial text block has the same interline distance between any consecutive lines (any two consecutive lines).

According to a particular embodiment, the initial interline ratio is determined as a function of the initial font size and the interline distance.

According to a particular embodiment, the determining of an updated interline ratio comprises: setting a current interline ratio as the initial interline ratio; selecting a next interline ratio, wherein the next interline ratio is the closest one of a set of predefined interline ratios to the current interline ratio, whereby the next interline ratio is incremented when the container height increased, or decremented when the container height decreased; determining a next number of lines of a next text block, wherein the next text block is defined by a next interline distance calculated based on the next interline ratio times the initial font size; calculating a next distortion by dividing the resized container height by the next number of lines; evaluating the next interline ratio by: (i) when the next interline distance is lower than the calculated distortion, setting the current interline ratio as the next interline ratio, and causing to repeat the selecting of the next interline ratio, the determining of the next number of lines, the calculating of the next distortion, the evaluating of the next interline ratio; (ii) when the next interline distance is higher than the distortion, setting the updated interline ratio as the current interline ratio.

According to a particular embodiment, the determining of an updated font size comprises: setting a current font size as the initial font size; selecting a next font size, wherein the next font size is the closest one of a set of predefined font size to the current font size, whereby the next font size is incremented when the container height is increased, or decremented when the container height is decreased; determining the next number of lines of the next text block, wherein the next text block is defined by the next interline distance calculated based on the updated interline ratio and the next font size; calculating a next distortion by dividing the resized container height by the next number of lines; evaluating the next font size by: (i) when the next interline distance is lower than the distortion, setting the current font size as the next font size, and repeating the selecting of a next font size, the determining of a next number of lines, the calculating of a next distortion, the evaluating of the next font size; (ii) when the next font size is higher than the distortion, setting the updated font size as the current font size.

According to a particular embodiment, a resized container width of the updated text block equals an initial container width of the initial container, said updated text block being reflowed within the resized container.

According to a particular embodiment, a resized container width is adjusted to include the same number of lines as the initial text block.

According to a particular embodiment, said text comprises typeset text.

According to a particular embodiment, said text further comprises handwriting text, wherein said handwriting text is rescaled in response to the resizing the initial container height.

According to a second aspect, the invention provides a computer readable program code (or computer program) including instructions for executing the steps of the method of the first aspect of the invention. This computer program may be stored on a recording medium and executable by a computing device, and more generally by a processor, this computer program comprising instructions adapted for the implementation of the method of the first aspect.

The computer program of the invention can be expressed in any programming language, and can be in the form of source code, object code, or any intermediary code between source code and object code, such that in a partially-compiled form, for instance, or in any other appropriate form.

According to a third aspect, the invention provides a non-transitory computer readable medium having a computer program of the second aspect recorded therein. This non-transitory computer readable medium can be any entity or device capable of storing the computer program. For example, the recording medium can comprise a storing means, such as a ROM memory (a CD-ROM or a ROM implemented in a microelectronic circuit), or a magnetic storing means such as a floppy disk or a hard disk for instance.

The non-transitory computer readable medium of the invention can correspond to a transmittable medium, such as an electrical or an optical signal, which can be conveyed via an electric or an optic cable, or by radio or any other appropriate means. The computer program according to the disclosure can in particular be downloaded from the Internet or a network of the like.

Alternatively, the non-transitory computer readable medium can correspond to an integrated circuit in which a computer program is loaded, the circuit being adapted to execute or to be used in the execution of the methods of the invention.

According to fourth aspect, the present invention relates to a computing device for rescaling an initial text block to maintain readability, said initial text block containing text arranged in multiple lines, having the same interline distance between any consecutive lines, according to an initial font size and an initial interline ratio, said initial interline ratio determined as a function of the initial font size and the interline distance, said computing device comprising:
a display area configured to display the initial text block enclosed in an initial container having an initial container height, said initial container including a block handle;
an input area configured to detect a user interaction gesture over the block handle;
a container resizer module configured to resize the initial container height into a resized container height according to the user interaction gesture, resulting in an updated interline distance;
an interline determination module configured to determine an updated interline ratio of said text in response to said the container resizer module; and
a font size determination module configured to determine an updated font size of said text in response to the interline determination module;
   wherein the display area is further configured to display an updated text block having the resized container height, said updated text block including said text arranged according to the updated interline ratio and the updated font size.

The various embodiments defined above in connection with the method of the first aspect apply in an analogous manner to the computing device, the computer program and the non-transitory computer readable medium of the present invention.

For each step (or operation) of the method of the first aspect of the present invention, the computing device of the fourth aspect may comprise a corresponding module configured to perform said step (or operation).

According to other embodiments, the interline determination module comprises:
a current interline establisher configured to set a current interline ratio as the initial interline ratio;
a next interline selector configured to select a next interline ratio, wherein the next interline ratio is the closest one of a set of predefined interline ratios to the current interline ratio, whereby the next interline ratio is incremented when the container height increased, or decremented when the container height decreased;
a next number of line determinator configured to determine a next number of lines of a next text block, wherein the next text block is defined by a next interline distance calculated based on the next interline ratio times the initial font size;
a next interline distortion calculator configured to calculate a next distortion by dividing the resized container height by the next number of lines;
a next interline evaluator configured to evaluate the next interline ratio by: (i) when the next interline distance is lower than the calculated interline distortion, setting the current interline ratio as the next interline ratio, and causing to repeat the steps of selecting of the next interline ratio, determining of the next number of lines, calculating of the next interline distortion and evaluating of the next interline ratio; (ii) when the next interline distance is higher than the distortion, setting the updated interline ratio as the current interline ratio.

According to other embodiments, the font size determination module comprises:
a current font size establisher configured to set a current font size as the initial font size;
a next font size selector configured to select a next font size, wherein the next font size is the closest one of a set of predefined font size to the current font size, whereby the next font size is incremented when the container height is increased, or decremented when the container height is decreased;
a next number of lines determinator configured to determining the next number of lines of the next text block, wherein the next text block defined by the next interline distance calculated based on the updated interline ratio and the next font size;
a next interline distortion calculator configured to calculate a next interline distortion by dividing the resized container height by the next number of lines;
a next font size evaluator configured to evaluate the next font size by: (i) when the next interline distance is lower than the interline distortion, setting the current font size as the next font size, and causing to repeat the selecting of a next font size, the determining of a next number of lines, the calculating of a next interline distortion, the evaluating of the next font size; (ii) when the next font size is higher than the interline distortion, setting the updated font size as the current font size.

Where functional modules are referred to in the present disclosure for carrying out various steps of the described method(s) it will be understood that these modules may be implemented in hardware, in software, or a combination of the two. When implemented in hardware, the modules may be implemented as one or more hardware modules, such as one or more application specific integrated circuits. When implemented in software, the modules may be implemented as one or more computer programs that are executed on one or more processors.

### BRIEF DESCRIPTION OF THE DRAWINGS

The present system and method will be more fully understood from the following detailed description of the examples thereof, taken together with the drawings. In the drawings like reference numerals depict like elements. In the drawings:

FIG. 1 shows a block diagram of a computing device in accordance with an embodiment of the present invention;

FIG. 2A shows typography information of typeset text;

FIG. 2B shows typography information of typeset text including spacing of a line pattern parameters of the typeset text of FIG. 2A;

FIG. 3A shows a text block example including a user interaction gesture to an input area on a computing device of the present invention;

FIG. 3B shows the text block of FIG. 3A modified according to the user interaction gesture of FIG. 3A, in accordance with a particular embodiment of the present invention;

FIG. 3C shows the text block of FIG. 3B modified according to the user interaction gesture of FIG. 3B, in accordance with a particular embodiment of the present invention;

FIG. 3D shows the text block of FIG. 3C modified according to the user interaction gesture of FIG. 3C, in accordance with a particular embodiment of the present invention;

FIG. 4 shows a flow diagram of an example of the present method for rescaling a text block according to a user interaction gesture over a block handle.

FIG. 5 shows an example of a mix type text block including typeset text and handwriting text.

Table 1 shows possible example transition values of interline distances as a function of predefined font sizes (in pt or Postscript point) and predefined interline ratios.

### DETAILED DESCRIPTION OF EXAMPLE EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Reference to and discussion of directional features such as up, down, above, below, lowest, highest, horizontal, vertical, etc., are made with respect to the Cartesian coordinate system as applied to the input interface on which the input to be recognized is made.

Further, the use of the term ‘text’ in the present disclosure is understood as encompassing all alphanumeric characters, and strings thereof, in any written language and common place non-alphanumeric characters, e.g., symbols, used in written text.

Furthermore, the term ‘non-text’ in the present disclosure is understood as encompassing freeform handwritten content and rendered text and image data, as well as non-alphanumeric characters, and strings thereof, and alphanumeric characters, and strings thereof, which are used in non-text contexts.

The systems and methods described herein may utilize recognition of users' natural writing or drawing styles input to a computing device via an input interface, such as a touch sensitive screen, connected to, or of, the computing device or via an input device, such as a digital pen or mouse, connected to the computing device. Whilst the various examples are described with respect to recognition of handwriting input using so-called online recognition techniques, it is understood that application is possible to other forms of input for recognition, such as offline recognition in which images rather than digital ink are recognized.

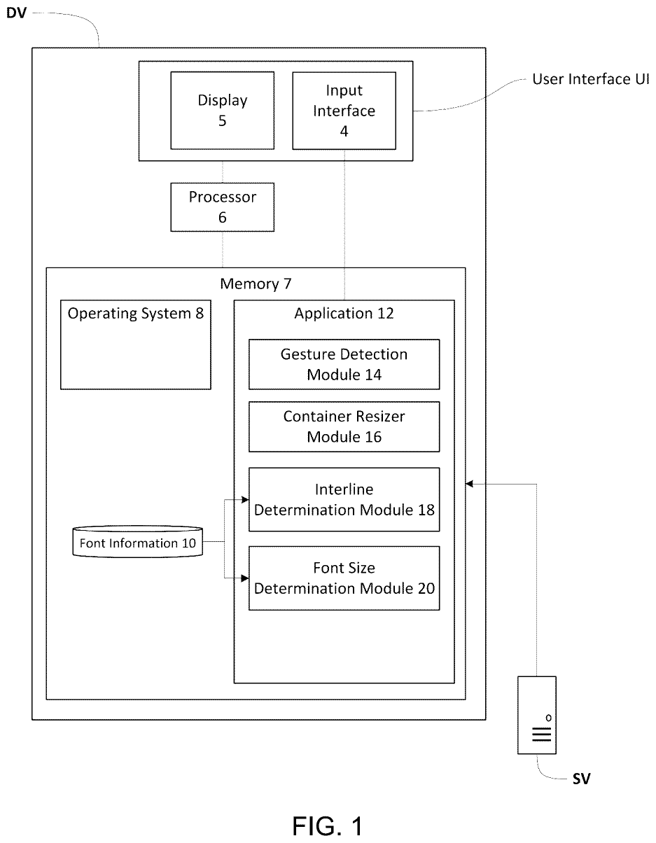

FIG. 1 illustrates a block diagram of a system, comprising a computing device DV, for rescaling an initial text block to maintain readability, said initial text block containing text arranged in multiple lines, having a same interline distance between any consecutive lines, according to an initial font size and an initial interline ratio, said initial interline ratio determined as a function of the initial font size and the interline distance.

The computing device DV may be a computer desktop, laptop computer, tablet computer, hybrid computers (2-in-1s), e-book reader, mobile phone, smartphone, wearable computer, digital watch, interactive whiteboard, global positioning system (GPS) unit, enterprise digital assistant (EDA), personal digital assistant (PDA), game console, or the like. The computing device DV includes components of at least one processing element, some form of memory and input and/or output (I/O) devices. The components communicate with each other through inputs and outputs, such as connectors, lines, buses, cables, buffers, electromagnetic links, networks, modems, transducers, IR ports, antennas, or others known to those of ordinary skill in the art.

In the illustrated example, the computing device DV comprises at least one display 5 for outputting data from the computing device such as images, text, and video. The display 5 may use LCD, plasma, LED, OLED, CRT, or any other appropriate technology that is or is not touch sensitive as known to those of ordinary skill in the art. At least some part of the display 5 may be co-located with at least one input interface (or input surface, or input area) 4. The input interface 4 may employ technology such as resistive, surface acoustic wave, capacitive, infrared grid, infrared acrylic projection, optical imaging, dispersive signal technology, acoustic pulse recognition, or any other appropriate technology as known to those of ordinary skill in the art to receive user input in the form of a touch- or proximity-sensitive surface. The input area 4 may be for instance a non-touch sensitive surface which is monitored by a position detection system. The input interface 4 may be bounded by a permanent or video-generated border that clearly identifies its boundaries. Instead of, or additional to, an on-board display, the computing device DV may have a projected display capability.

The computing device DV also includes a processor 6, which is a hardware device for executing software, particularly software stored in memory 7. The processor 6 can be any custom made or commercially available general purpose processor, a central processing unit (CPU), commercially available microprocessors including a semiconductor based microprocessor (in the form of a microchip or chipset), microcontroller, digital signal processor (DSP), application specific integrated circuit (ASIC), field programmable gate array (FPGA) or other programmable logic device, discrete gate or transistor logic, discrete hardware components, state machine, or any combination thereof designed for executing software instructions known to those of ordinary skill in the art.

The memory 7 can include any one or a combination of volatile memory elements (e.g., random access memory (RAM, such as DRAM, SRAM, or SDRAM)) and nonvolatile memory elements (e.g., ROM, EPROM, flash PROM, EEPROM, hard drive, magnetic or optical tape, memory registers, CD-ROM, WORM, DVD, redundant array of inexpensive disks (RAID), another direct access storage device (DASD), or any other magnetic, resistive or phase-change nonvolatile memory). Moreover, the memory 7 may incorporate electronic, magnetic, optical, and/or other types of storage media. The memory 7 can have a distributed architecture where various components are situated remote from one another but can also be accessed by the processor 6.

Further, the memory 7 may be remote from the device DV, such as at a server or cloud-based system, which is remotely accessible by the computing device DV.

The memory 7 is coupled to the processor 6, thereby enabling the processor 6 to read information from and write information to the memory 7. In the alternative, the memory 7 may be integral to the processor 6. In another example, the processor 6 and the memory 7 may both reside in a single ASIC or other integrated circuit.

The software in the memory 7 includes an operating system 8 and an application 12 in the form of a non-transitory computer readable medium having a computer readable program code (or computer program) embodied therein. The operating system 8 controls the execution of the application 12. The operating system 8 may be any proprietary operating system or a commercially or freely available operating system, such as WEBOS, WINDOWS®, MAC and IPHONE OS®, LINUX, and ANDROID. It is understood that other operating systems may also be utilized. Alternatively, the application 12 of the present system and method may be provided without use of an operating system.

The application 12 includes one or more processing elements related to detection, management and treatment of user input (discussed in detail later). In particular, the application 12 may comprise instructions for executing a method of the invention, as described further below in particular embodiments.

The software may also include one or more other applications related to handwriting recognition, different functions, or both. Some examples of other applications include a text editor, telephone dialer, contacts directory, instant messaging facility, computer-aided design (CAD) program, email program, word processing program, web browser, and camera.

The application 12, with support and compliance capabilities, may be a source program, executable program (object code), script, application, or any other entity having a set of instructions to be performed. When a source program, the program needs to be translated via a compiler, assembler, interpreter, or the like, which may or may not be included within the memory, so as to operate properly in connection with the operating system. Furthermore, the application with support and compliance capabilities can be written as (a) an object oriented programming language, which has classes of data and methods; (b) a procedure programming language, which has routines, subroutines, and/or functions, for example but not limited to C, C++, Pascal, Basic, Fortran, Cobol, Perl, Java, Objective C, Swift, and Ada; or (c) functional programing languages for example but no limited to Hope, Rex, Common Lisp, Scheme, Clojure, Racket, Erlang, OCaml, Haskell, Prolog, and F#.

User input entered on or via the input interface 4 may be processed by the processor 6 as digital ink. A user may enter a handwriting input by any appropriate means, for instance with a finger or some instrument such as a pen or stylus suitable for use with the input interface. The user may also enter a handwriting input by making a gesture above the input interface 4 if technology that senses or images motion in the vicinity of the input interface 4 is being used, or with a peripheral device of the computing device DV, such as a mouse or joystick, or with a projected interface, e.g., image processing of a passive plane surface to determine the stroke and gesture signals.

The computing device DV may be configured to process various types of user input, including text input (or text content) that may take various forms such handwriting text and/or typeset text. On the computing device DV, the input elements can be typeset from a keyboard, hand-drawn or handwritten from a pen or a finger by a user, etc. The input elements can be displayed as digital ink or typeset version.

A handwriting (or hand-drawn) input is formed of (or comprises) one or plural strokes. Each stroke is characterized by at least a stroke initiation location, a stroke termination location, and a path connecting the stroke initiation and termination locations. Further information such as timing, pressure, angle at a number of sample points along the path may also be captured to provide deeper detail of the strokes.

According to a particular embodiment, when running the applications 12 stored in the memory 7 (FIG. 1), the processor 6 implements modules, namely: a gesture detection module 14, a container resizer module 16, a interline ratio determination module 18 and a font size determination module 20. Particular implementations of these modules are described hereafter by way of examples.

The gesture detection module 14 (or the display area 4) is configured to detect, on the input interface 4, a user interaction gesture over a block handle. This user interaction gesture, which take various forms, defines a user interaction with the block handle displayed by the display 5. This use interaction may comprise selecting and moving the block handle as further described below in particular embodiments.

More specifically, a text block—named initial text block—may be displayed by the display 5, this initial text block being enclosed in an initial container having an initial container height. This initial container may include a block handle with which a user may interact by performing a user interaction gesture which the gesture detection module 14 is configured to detect.

The text contained in the initial text block may be arranged according to an initial font size and an initial interline ratio. The multiples lines of this text may have (or be arranged according to) a same interline distance between any consecutive lines. In other words, any pair of consecutive lines in the text may be spaced apart by this same interline distance (also called initial interline distance).

In a particular example, the initial interline ratio is determined as a function of the initial font size and the initial interline distance.

In a particular example, the user interaction gesture, such as a pen or a finger passing over a text block, causes display of a container and the block handle, surrounding the text block. The block handle may be displayed on a lower or upper horizontal side of the container. The user interaction gesture may further include a selection of the block handle and the associated container. The user interaction gesture is for example a drag/push of the selected handle across the interface so as to provide modification and alteration of the selected container as further explained below. The selection of the block handle may include a resizing operation, such as a drag/push of the selected handle across the interface, in a vertical direction, in an upward or downward direction.

The container resizing module 16 (also referred to as the container resizer) is configured to resize a selected container, such as the above-mentioned initial container of the initial text block. In particular, the container resizing module 16 is configured to resize the initial container height into a resized container height according to the user interaction gesture detected by the gesture detection module 14, thereby resulting in an updated interline distance. In other words, the resizing operation through the block handle causes the initial container height of the initial container to be modified by a container height variation according to the user interaction gesture. The initial container is thus converted (or resized, or rearranged) by this resizing operation into a resized container—also called updated container—having the resized container height. This conversion (or resizing) causes the initial interline distance of the text in the initial text block to be modified into an updated interline distance (different from the initial interline distance).

The modified container height is also referred to as a resized container height. The container height variation may be positive when the resizing operation causes the initial container height to increase in height, or negative when the resizing operation causes the initial container height to decrease in height.

This resizing operation may cause further modification to the text block enclosed in the container, including modification of the initial typography of the initial text block, defined by an initial interline ratio and an initial font size, as further explained below.

In a particular example, prior to the resizing operation, the initial text block contains text arranged in a multiple lines according to an initial font size and an initial interline ratio. The resizing operation performed by the container resizer module 16 may cause modifications of the font size and initial interline ratio according to which the text is arranged in the resized container.

In the present disclosure, a font size of a text defines the size of said text on display. A font may be measured in points or pixels for instance. In particular, font size may define the height of text content, such as the height of text symbols (letters, numbers, etc.). By adapting the font size of a text content, one can adapt the way it appears on display.

In the present disclosure, an interline ratio (also called interline setting or interline spacing) defines a distance or spacing between the lines of a text, also called interline distance or interline spacing respectively.

For instance, default font sizes for digital display of fontified or typeset characters may be set based on legibility requirements and device display characteristics. In typography, the legibility of typeset text refers to visual clarity of individual symbols and the geometrical distribution between them in a piece of text. The overall legibility of a typeset text is related to characteristics inherent to the design of the text which relate to the ability to distinguish one symbol from another and to the optimization of the readability. Characteristics that affect legibility include different character and line height features as further described below.

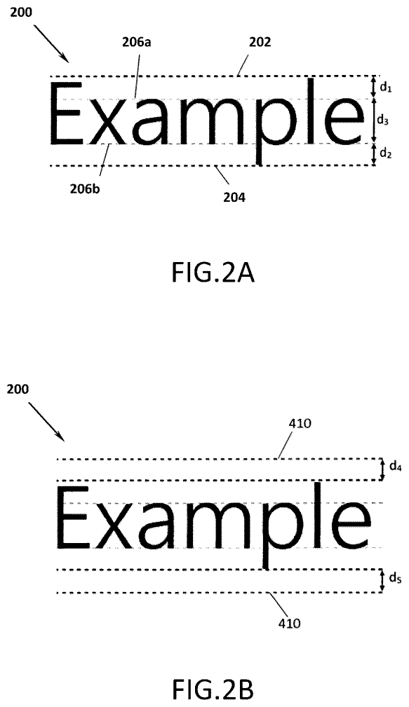

FIG. 2A shows example parameters of typeset text settings for an example text word 200, being “Example”. The text 200 has an upper extent (illustrated as dashed line 202) defined by the ascenders of the text characters, e.g., the character “I”, and a lower extent (illustrated as dashed line 204) defined by the descenders of the text characters, e.g., the character “p”. These extents are spaced from respective upper and lower nominal extents (illustrated as dashed lines 206a and 206b, respectively) which define the nominal height of the text characters without ascenders and descenders. The lower nominal extent is also referred to as base line. The upper extent line 202 is spaced a distance d1 from the upper nominal extent line 206a. The lower extent line 204 is spaced a distance d2 from the lower nominal extent line 206b. The nominal extent, i.e., the distance between the upper and lower nominal extent lines 206a and 206b, is a distance d3. Accordingly, the font size or text height, D, is defined as d1+d3+d2.

In the system and method of the present invention, the font size is set so that it provides rational legibility of the typeset text according to a line pattern background 410 to improve readability. FIG. 2B shows horizontal lines of the line pattern 410 with the line 410 above the text 200 being spaced a distance d4 from the upper extent line 202 and the line 410 below the text 200 being spaced a distance d5 from the lower extent line 204. The values of d4 and d5 may be set based on typical line spacing used for paper, for example.

A vertical rhythm may be based on a line height or interline distance, also simply referred to as “interline”, representing the distance between two adjacent base lines provided as a multiple of the font size. Typical typographic rules define that text is best read with an interline ratio in-between 1.3 and 1.7 times its font size. Accordingly, an interline ratio may be set at about 1.3 to about 1.7 times the typeset text size. Setting an interline ratio to be a regular number that can be multiplied easily avoids non-integer sizing, which would lead to blurred rendering. Accordingly, possible interline ratios are set at, for example, 1.3, 1.5 or 1.7.

As explained above, the interline distance may be calculated as a function of the font size times the interline ratio. In a particular example, possible interline ratios and possible font sizes are set respectively as predefined interline ratios and predefined font sizes in a font information 10 (FIG. 1) stored in the memory 7. Therefore, the possible interlines of the system are discrete values, wherein possible interline distances may be discrete points of a distance as a function of a combination of a predefined font size and a predefined interline ratio as illustrated in Table 1.

As a consequence of the resizing of the selected container, the present system may spread the container height variation among a number of the text lines of an updated text block. Accordingly, the modified space available per line, also referred to as interline distortion, implies further determination of sensible typography of the typeset text to maintain rational legibility of the text block according to the resized container, as further explained below to maintain readability.

The container height variation and the interline distortion may allow modification (transition) of the interline distance among discrete interline distances available from the system as illustrated in Table 1. Although, the interline distortion is a continuous value following the container height variation, the interline distance is a discrete value set by the system and method according to the predefined font sizes and predefined interline ratios. The determination of an updated font size and an updated interline ratio defining an updated interline distance is further explained below.

Still as shown in FIG. 1, the interline ratio determination module 18 is configured to determine an updated interline ratio of the updated text block resulting for the resizing operation to the initial text block. The initial interline ratio of the initial text block is thus updated (or converted) into the updated interline ratio of the updated text block.

The interline ratio determination module 18 is configured to determine the updated interline ratio based on the resized container height determined by the container resizer module 16. The correlation between the resized container height and the updated interline ratio may be adapted depending on each case. In a particular example, the initial interline equals to the initial font size times the initial interline ratio.

In a particular example, following the resizing of the initial container height by the container resizer module 16, an interline ratio selector (not shown) of the interline ratio determination module 18 is configured to select a next interline ratio retrieved from the set of predefined interline factors of the font information 10. The next interline ratio allows to calculate a next interline distance based on the initial font size times the next interline ratio. The next interline ratio is selected as the closest predefined interline ratio to a current interline ratio, wherein the next interline ratio is incremented when the container height is increased and the container height variation is positive, and/or the next interline ratio is decremented when the container height is decreased, and the container height variation is negative.

Then, at a first iteration of the interline ratio selector, the current interline ratio may be set as the initial interline ratio.

Next, at following iterations of the interline ratio selector, the current interline ratio may be further set as the next interline ratio depending on the outcome of an interline comparator. A current interline distance and a next interline distance may be deducted from the current and the next interline ratios as factors of the initial font size, respectively.

In a particular example, the interline determination module 18 may include a interline distortion calculator (not shown) configured to determine a next number of lines of a next text block and calculate a next interline distortion by dividing the container height by the next number of lines.

The interline determination module 18 may be able to classify text and shapes, and within text, text lines, paragraphs defined as a coherent set of text lines. Further, the present system is able to analyze the layout of shapes and text and alignment of individual text or non-text blocks within the container.

The interline distortion calculator may retrieve the next number of lines of the next text block arising form the next interline of the interline ratio selector. The interline distortion calculator may retrieve the resized height resulting from the container resizer. Therefore, the interline distortion may be calculated in this example by dividing the resized height by the next number of lines of the next text block. The interline distortion represents an indicator of a modified space available per line following the resizing operation.

Standard typographic rules applying to typeset text content of the container may have to be adjusted to the modified space available to maintain rational legibility of the typography according to the resized container to maintain readability. Therefore, the interline determination module 20 may include an interline comparator (not shown) configured to compare the next interline with the interline distortion. The interline comparator may determine (or identify) whether the next interline fits into the interline distortion. The interline comparator may detect one of three following outcomes or results: (i) when the next interline is lower than the interline distortion, it indicates that the next interline ratio is a possible updated interline ratio, (ii) when the next interline is higher than the interline distortion, it indicates that the next interline distance does not allow the next text block to fit into the resized container, or (iii) when the next interline ratio is the last item of the predefined interline ratios from the font information 10 stored in the memory, it indicates that the next interline ratio is the updated interline ratio (although it may not be optimum to the interline distortion).

In the first above-mentioned outcome of the interline comparator, the next interline distance is lower than the interline distortion, therefore the current interline ratio may be set as the next interline ratio and the next interline ratio may be set by the interline ratio selector through at least another iteration of the selector. Further the interline distortion calculator may retrieve the next number of lines of the next text block and the next interline distortion and, the interline determination module may thus compare the next interline with the next interline distortion through the at least other iteration of the interline distortion calculator and the interline comparator.

In the second above-mentioned outcome of the interline comparator, the next interline is higher than the next interline distortion, therefore the next interline distance does not fit into the resized container and is excluded as a possible interline ratio to update the initial text block typography. The updated interline ratio may be set from the previous iteration of the interline ratio selector therefore the current interline ratio.

In the third above-mentioned outcome of the interline comparator, the next interline ratio reaches the last item of the predefined interline ratios of the font information 10 stored in the memory, either the highest possible interline ratio when the next interline ratio is incremented or the lowest possible interline ratio when the next interline ratio is decremented. In this third outcome, the updated interline ratio is set as indicated above although it may not fulfill a rational legibility of the typeset text to maintain readable display of the text box enclosed in the resized container. For example, although the interline ratio is the smallest interline ratio available, the initial font size may not fit in the resized container and the modified space available per line. In another example, although the interline ratio is the highest interline ratio available, the resized container and the modified space available per line may still leave some space per line which does not comply with rational legibility of the typography. The third outcome of the interline comparator may implement a further operation (or stage of the system) aimed at determining an updated font size as further explained below.

The font size determination module 20 (FIG. 1) is configured to determine an updated font size of the updated text block. The font size determination module 20 is configured to determine the updated font size based on the resized container height determined by the container resizer module 16 and the updated interline ratio determined by the interline determination module 18. The correlation between the updated font size, on the one hand, and the resized container height and the updated interline ratio on the other hand, may be adapted depending on each case.

In a particular example, following the determination of the updated interline ratio, a font size selector (not shown) of the font size determination module may be configured to select, a next font size. The next font size may be selected from a set of predefined font size of the font information 10. The next font size may be the closest predefined font size to a current font size, wherein the next font size is incremented when the container height has been increased and the container height variation is positive, and/or the next font size is decremented when the container height has been decreased and the container height variation is negative. Then, at a first iteration of the font size selector, the current font size may be set as the initial font size. Next, at following iterations of the font size selector, the current font size is further set as the next font size, resulting from the outcome of a font size comparator. A current interline distance and a next interline distance may thus be deducted from the current and the next font sizes times the updated interline ratio.

In a particular example, the font size determination module 20 includes an interline distortion calculator (not shown) configured to determine a next number of lines of a next text block and calculate a next interline distortion by dividing the container height by the next number of lines, as explained here over.

In a particular example, the font size determination module 20 includes a font size comparator (not shown) configured to compare the next font size with the next interline distortion. The font size comparator may determine (or identify) whether the next font size fits into the next interline distortion. The font size comparator may be configured to detect the two following results or outcomes: (i) when the next font size is lower than the next interline distortion, it indicates that the next font size is a possible updated font size, (ii) when the next font size is higher than the next interline distortion, it indicates that the next font size does not allow the next text block to fit into the resized container.

In the first above-mentioned outcome of the font size comparator, the next font size is lower than the next interline distortion, therefore the current font size may be set as the next font size and the next font size may be set by the font size selector through at least another iteration of the font size selector. Further the interline distortion calculator may retrieve the next number of lines and the next interline distortion and, the font size comparator may compare the next font size with the next interline distortion through the at least other iteration of the interline distortion calculator and the font size comparator. The two possible outcomes of the at least other iteration of the font size comparator are similar as presently described.

In the second above-mentioned outcome of the font size comparator, the next font size is higher than the next interline distortion, therefore the next font size is higher than the next interline distortion and is excluded as a possible font size to update the text block typography. The updated font size may be set from the previous iteration of the font size selector as the current font size.

Further, the display 5 of the computing device DV may be configured to display the updated text block enclosed in a resized container having the resized container height (determined by the container resizer module 16), said updated text block including the text of the initial text block but arranged according the updated interline ratio (determined by the interline determination module 18) and the updated font size (determined by the font size determination module 20).

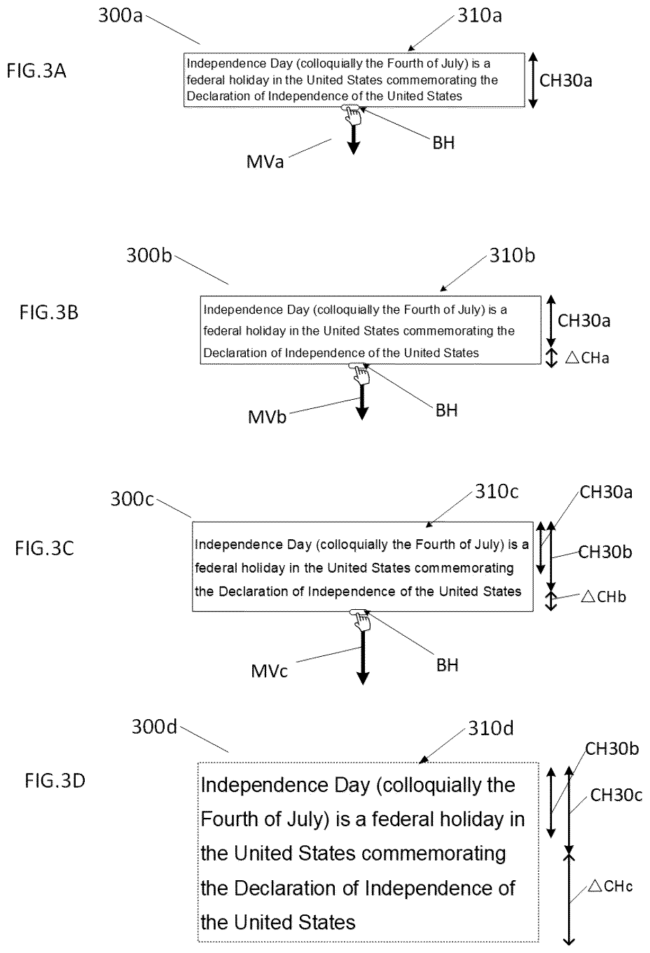

Below are now described examples of implementation of a method implemented by the computing device DV (FIG. 1) for rescaling an initial text block containing text, with reference to FIG. 3A-3D. To this end, the computing device DV may execute instructions of the computer program 12.

FIG. 3A shows, on the display area 5 of the computing device DV, a text block 300a enclosed in a container 310a including a block handle BH, wherein the container 310a is defined by (or has) a container height CH30a. The text block 300a and the container 310a constitute respectively an initial text block and an initial container within the sense of the present invention. The container height CH30a is also named initial container height.

As an example, illustrated on FIG. 3A, the container height CH30a is 15 mm (millimeters). The text block 300a includes text, i.e. a text content arranged (and displayed) in multiple lines according to an initial typography, in particular according to an initial font size and an initial interline ratio. By way of an example, the text of the text block 300a is distributed in three lines according to an initial typography which is defined by an initial font size and an initial interline ratio. The initial typography may further be defined by a font type of the text.

In a particular example, the multiple lines of the text are arranged according to a same initial interline distance between each pair of consecutive lines. The initial interline ratio may be determined as a function of the initial font size and the initial interline distance.

As an example, the font type is set as Arial, with an initial font size of 10 pt and an initial interline ratio of 1.3. The font size is converted into typographic and digital imaging units such as points (pt). The point is the usual unit for measuring font sizes and distances between lines of typeset text. A desktop publishing point also called a PostScript point is defined as 0.3527 millimeters. The initial interline distance may be deduced from the initial font size (10 pt is 3.53 mm) times the initial interline ratio as 3.53×1.3=4.59 mm.

As illustrated, the initial container 300a comprises a block handle BH for user interaction. The computing device DV may detect, in the input area 4, a user interaction gesture MVa over (or in interaction with) the block handle BH.

More specifically, the first user interaction gesture MVa is represented by way of an example as a hand hovering over a lower bound of the text block causing the display of the container 310a and the block handle BH. The user interaction gesture MVa may include a selection gesture MVa of the block handle BH such as, for example, a dragging gesture in a dragging direction, which in this case is the downward direction as represented by the arrow (FIG. 3A) of the interaction gesture MVa. The first interaction gesture MVa triggers the alteration of the container height CH30a by the computing device DV, as further represented in FIG. 3B. Additionally, the alteration of the container height, an increase of the container height in this example, causes the modification of the initial typography of the text block, as further explained below.

FIG. 3B illustrates an example of an implementation of the present system and method. FIG. 3B shows, on the display area 5 of the computing device DV, a first updated version (named updated text block) 300b of the initial text block 300a (FIG. 3A), said updated text block 300b being enclosed in a first resized container 310b as a result of the performance of the first interaction gesture MVa of FIG. 3A. In other words, the initial container 310a having the initial container height CH30a is resized (or converted) into a first resized container 310b having a resized container height CH30b different from the initial container height, as described below.

The text block 300b enclosed in the resized container 310b includes the same text as the initial text block 300a but arranged (and displayed) according to a different updated typography, that is, its text content is displayed over the three lines according to a first updated typography defined by the same initial font size as the initial text block 300 and a first updated interline ratio different from the initial interline ratio.

As shown in the example of FIG. 3B, the first resized container 310b is defined by a first container height CH30b corresponding to the initial container height CH30a increased by a first container height variation ΔCHa. As a result, the initial container height CH30a is increased by ΔCHa to form the updated container height CH30b which is greater than the initial container height CH30a. As an example, the first container height CH30b is here of 19 mm. The first updated version of the text block 300b is displayed in response to the determination of a first updated interline ratio according to the present system and method.

In a particular example of the system and method of the present invention, it is determined if the predefined interline ratios stored in the font information 10 are possible options for displaying the content of the text block enclosed in the first resized container 310b, therefore optimizing the space created by the user. The current interline ratio is set as the initial interline ratio (1.3 in this example). A first next interline ratio is selected as the closest of the set of predefined interline ratios to the current interline ratio, whereby the first next interline ratio is incremented since the initial container height has been increased and the first variation ΔΔCha is positive. The first next interline ratio available from the font information 10 is, for example 1.5, therefore the first next interline distance is deduced from the font size (10° pt is 3.53°mm) times the first next interline ratio as 3.53×1.5=5.29° mm.

A first next number of lines is determined. A first next interline distortion is calculated by dividing the container height CH30b by the next number of lines, resulting in the next interline distortion of 19/3=6.33 mm. As the first next font size is lower than the next interline distortion, the present system and method may perform another iteration of the above-described determining stages.

The current interline ratio is set as the first interline ratio (1.5 in this example). A second next interline ratio is selected as the closest of the set of predefined interline ratios to the current interline ratio. The second next interline ratio available from the font information 10 is, for example 1.7, therefore the second next interline distance is deduced from the font size (10° pt is 3.53° mm) times the second next interline ratio as 3.53×1.7=6° mm.

The second next interline is compared with a second next interline distortion.

A second next number of lines is determined. The second next interline distortion is calculated by dividing the container height CH30b by the next number of lines, resulting in the next interline distortion of 19/3=6.33 mm. As the second next interline distance is lower than the next interline distortion, the present system and method may perform another iteration of the above-described determining stages.

However, the second next interline ratio is the highest item of the predefined interline ratios available from the font information 10, therefore the first updated interline ratio is set as the second next interline ratio (1.7 in this example). The second next interline distance being lower the second next interline distortion, there may still be some available space to be optimized for an improved readability of the content of the text block, therefore the present system and method is determining if the predefined font sizes stored in the font information 10 are possible options for updating the first typography of the content of the text block 300b.

The current font size is set as the initial font size (10° pt in this example). A first next font size is selected as the closest of the set of predefined font sizes to the current font size, whereby the first next font size is incremented since the container height has been increased. The first next font size available from the font information 10 is, for example 11° pt, therefore the third next interline distance is deduced from the font size (11° pt is 3.88° mm) times the updated interline ratio as 3.88×1.7=6.59° mm.

A third next number of lines of the text block is determined. The first next font size is compared with a third next interline distortion. The third next interline distortion is calculated by dividing the container height CH30b by the third next number of lines, resulting in the third next interline distortion of 19/3=6.33 mm.

As the first font size step is higher than the first interline distortion, the first next font size is excluded as a possible font size to update the text block typography. The first next font size would not fit into the first resized container; therefore, the first updated font size is set as the current font size which is the initial font size.

As a consequence, the FIG. 3B shows the resized container 310b, including an altered container height CH30b resulting from the container height variation ΔCHa according to the first interaction gesture MVa. The first resized container 310b encloses the first updated text block 300b displayed according to a first updated typography, including the second next interline ratio and the initial font size, as determined by the present system and method and described thereover.

Furthermore, FIG. 3B shows a second user interaction gesture MVb detected by the computing device, this gesture being represented in this example as a hand hovering over a lower bound of the text block causing the display of the container 310b and the block handle BH. Similarly to the first interaction gesture MVa, the second interaction gesture MVb may be a dragging gesture in the downward direction as represented by the black arrow of the interaction gesture MVb. The second interaction gesture MVb triggers the alteration of the container height CH30b by the computing device DV, as further represented in FIG. 3C. Additionally, the alteration of the container height, i.e. an increase of the container height in this example, causes the modification of the first updated typography of the text block, as further explained below.

As determined according to the system and method of particular embodiments of the invention, the font size of the text block 300b remains the initial font size of 10 pt and the first updated interline ratio is 1.7. The first updated typography is determined to fit in the resized container and the modified space available per line following the first interaction gesture.

FIG. 3C illustrates another example of an implementation of the present system and method. FIG. 3C shows, on the display area 5 of the computing device DV, a second updated version (named second updated text block) 300c of the text block of the FIGS. 3A and 3B, said second updated text block 300c being enclosed in a second resized container 310c as a result of the performance of the second interaction gesture MVb of FIG. 3B. In other words, the resized container 310b having the resized container height CH30b is resized (or converted) into a second resized container 310c having a resized container height CH30c different from the resized container height CH30b, as described below.

The second updated text block 300c enclosed in the resized container 310c includes the same text as the text blocks 300a and 300b (FIGS. 3A and 3B) but arranged (and displayed) according to a different updated typography, that is, its text content is displayed over the three lines according to a second updated typography defined by a different font size and a different interline ratio from the ones of the first updated text block 300b.

As shown in the example of FIG. 3C, the second resized container 310c is defined by a container height CH30c (not shown) corresponding to the resized container height CH30b increased by a container height variation ΔCHb. As an example, the container height CH30c is here of 25 mm. The updated version of the text block 300c is displayed in response to the determination of an updated font size according to the present system and method.

The first resized container 310b enclosing the first updated typography of the text block is now considered as the initial container enclosing the initial typography.

In a particular example of the present system and method, it is determined if the predefined interline ratios stored in the font information 10 are possible options for a possible display of the content of the text block enclosed in the resized container 310c, optimizing the space created by the user. The current interline ratio is set as the initial interline ratio, here the second updated interline ratio being 1.7 in this example. However, the initial interline ratio is the highest item of the predefined interline ratios available from the font information 10. Nevertheless, there may still be some available space to be optimized for an improved legibility of the content of the text block, therefore the present system and method is determining if the predefined font sizes stored in the font information 10 are possible options for updating the typography of the content of the text block 300b.

The current font size is set as the initial font size (10° pt in this example). The first next font size is selected as the closest of the set of predefined font sizes to the current font size, whereby the first next font size is incremented since the container height has been increased. The first next font size available from the font information 10 is, for example 11° pt, therefore the first next interline distance is deduced from the font size (11° pt is 3.88° mm) times the initial interline ratio as 3.88×1.7=6.59° mm.

The first next font size is compared with a first next interline distortion.

A first next number of lines is determined. A first next interline distortion is calculated by dividing the container height CH30c by the next number of lines, resulting in the next interline distortion of 25/3=8.33 mm. As the first next font size is lower than the next interline distortion, the present system and method may perform another iteration of the above-described determining stages.

The current font size is set as the next first font size (11° pt in this example). A second next font size is selected as the closest of the set of predefined font sizes to the current font size. The second next font size available from the font information 10 is, for example 12° pt, therefore the second next interline distance is deduced from the font size (12° pt is 4.2324° mm) times the interline ratio as 4.2324×1.7=7.19508° mm.

The second font size is compared with a second next interline distortion.

A second next number of lines is determined. A second next interline distortion is calculated by dividing the container height CH30c by the second next number of lines, resulting in the next interline distortion of 25/4=6.25° mm. The second next font size is compared with the second next interline distortion.

Since the second next font size is higher than the second next interline distortion, the second next font size is excluded as a possible font size to update the text block typography. The second next font size would not fit into the resized container; therefore, the updated font size is set as the current font size.

Therefore, the FIG. 3C shows the resized container 310c, including the altered container height CH30c resulting from the container height variation ΔCHb according to the second interaction gesture MVb. The resized container 310c encloses the updated text block 300c displayed according to the second updated typography, including the second next interline ratio and the second next font size, as determined by the present system and method and described thereover.

Furthermore, in a particular example, FIG. 3C shows a third user interaction gesture MVc that is detected by the computing device, this gesture being represented in this example as a hand hovering over a lower bound of the text block causing the display of the container 310c and the block handle BH. Similarly, to the first and second interaction gestures, the third interaction gesture MVc is a dragging gesture in the downward direction as represented by the black arrow of the interaction gesture MVc. The third interaction gesture MVc triggers the alteration of the container height CH30c, as further represented in FIG. 3D.

The second updated typography is defined according to the present embodiment of the system and method by: the same font type, a second different updated font size (e.g., of 11 pt) determined in response to the second interaction gesture MVb and the same first updated interline ratio of 1.7 determined in response to the first interaction gesture MVa.

According to another example (not shown), the next iteration of the determining stages may be the determination of an updated interline ratio again, whereas the updated interline ratio is set back to the lowest item of the predetermined list of interline ratios. Indeed, as the updated font size is now set as the next font size of 11 pt, the updated interline ratio may be redetermined according to the above-described interline ratio determining stages. An iteration of the updated font size is lowering the updated interline distance as shown in the example of Table 1. It is noted that the values presented in Table 1 below are merely one example set of values out of many possible combinations of values depending on the typography, the font range and the interline distance range selected or set by the related application settings or preferences. For example, stepping (or switching) from the typography t6 of interline distance (interline ratio) of 17 mm to the typography t7 of interline distance of 14.3 mm, allows freeing some space between the lines which may allow to redetermine the updated interline ratio. Therefore, the updated interline ratio may be redetermined after each iteration of the updated font size to reach an optimized updated typography, wherein an optimized updated typography is maximizing the available space created by the interline distortion.

TABLE 1

| Typography | t1 | t2 | t3 | t4 | t5 | t6 | t7 | t8 | t9 | t10 | t11 | t12 | t13 | t14 | t15 | t16 | t17 | t18 |
|---|---|---|---|---|---|---|---|---|---|---|---|---|---|---|---|---|---|---|
| Font size | 8 | 8 | 8 | 10 | 10 | 10 | 11 | 11 | 11 | 12 | 12 | 12 | 14 | 14 | 14 | 16 | 16 | 16 |
| Interline ratio | 1.3 | 1.5 | 1.7 | 1.3 | 1.5 | 1.7 | 1.3 | 1.5 | 1.7 | 1.3 | 1.5 | 1.7 | 1.3 | 1.5 | 1.7 | 1.3 | 1.5 | 1.7 |
| Interline distance | 10.4 | 12.0 | 13.6 | 13.0 | 15.0 | 17.0 | 14.3 | 16.5 | 18.7 | 15.6 | 18.0 | 20.4 | 18.2 | 21.0 | 23.8 | 20.8 | 24.0 | 27.2 |
| (mm) | | | | | | | | | | | | | | | | | | |

Additionally, the alteration of the container height when the container height is further increased may cause the modification of the second updated typography of the text block, as further explained below.

FIG. 3D illustrated another example of implementation of the system and method of the present invention. FIG. 3D shows, on the display area 5 of the computing device DV, a third updated version (named updated text block) 300d of the text block of the FIGS. 3A, 3B and 3C, this updated text block 300d being enclosed in a third resized container 310d as a result of the performance of the third interaction gesture MVc of FIG. 3C. In other words, the second resized container 310c having the resized container height CH30c is resized (or converted) into a third resized container 310d having a resized container height CH30d different from the resized container height CH30c, as described below.

The third resized container 310d is represented in dashed line as it may not be displayed on the display area since no interaction gesture is performed over the area of the text block. The updated text block 300d enclosed in the resized container 310d includes the same text content as the text blocks of FIGS. 3A, 3B and 3C but arranged (and displayed) in a different number of lines (different line layout), that is, over five lines (instead of 3), this arrangement being in accordance with a third updated typography (different interline ratio and different font size).

As shown in FIG. 3D, the third resized container 310d is defined by a container height CH30d (not shown) corresponding to the resized container height CH30c of the updated text block 300c increased by a container height variation ΔCHc. As an example, the container height CH30c may be here of 50 mm. The updated version of the text block 300d is displayed in response to the determination of an updated font size according to the present system and method.

The second resized container 310c enclosing the second updated typography of the text block is now considered as the initial container enclosing the initial typography.

In a particular example of the present system and method, it is determined if the predefined interline ratios stored in the font information 10 are possible options for a possible display of the content of the text block enclosed in the resized container 310d, optimizing the space created by the user. The current interline ratio is set as the initial interline ratio, here the second updated interline ratio being 1.7 in this example. However, the initial interline ratio is the highest item of the predefined interline ratios available from the font information 10. Nevertheless, there may still be some available space to be optimized for an improved readability of the content of the text block, therefore the present system and method is determining if the predefined font sizes stored in the font information 10 are possible options for updating the typography of the content of the text block 300c.

The current font size is set as the initial font size (11 pt in this example). The next font sizes are selected from the set of predefined font sizes, whereby the next font sizes are incremented since the container height has been increased. The first, second and third next font sizes available from the font information 10 are, for example 12 pt, 14 pt and 16 pt, therefore the first, second and third next interline distances are deduced from the next font sizes times the initial interline ratio therefore the first, second and third next interlines are 7.19 mm, 8.4 mm and 9.59 mm.

The first, second and second next font sizes are compared with a first, second and third next interline distortions through three iterations of the font size determining stages.

First, second and third next numbers of lines are determined. First, second and third next interline distortions are calculated by dividing the container height CH30d by the first, second and third next numbers of lines, resulting in the first and second next interline distortions of 12.5 mm both and, the third next interline distortion of 10° mm. As the first, second and third next font sizes are lower than the first, second and third next interline distortions respectively, the present system and method may perform another iteration of the above-described determining stages.

After the third iteration of font size determining stages, the current font size is set as the third second font size (16 pt in this example). A fourth next font size is selected as the closest of the set of predefined font sizes to the current font size. The fourth next font size available from the font information 10 is, for example 18 pt, therefore the fourth next interline distance is deduced from the font size (18 pt is 6.35 mm) times the interline ratio as 6.35×1.7=10.79 mm.

The fourth font size is compared with a fourth next interline distortion.

A fourth next number of lines is determined. A fourth next interline distortion is calculated by dividing the container height CH30d by the fourth next number of lines, resulting in the next interline distortion of 50/6=8.33°mm. The fourth next font size is compared with the second next interline distortion.

Since the fourth next font size is higher than the fourth next interline distortion, the fourth next font size is excluded as a possible font size to update the text block typography. The fourth next font size would not fit into the resized container; therefore, the updated font size is set as the current font size.

Therefore, the FIG. 3D shows the resized container 310d, including the altered container height CH30d resulting from the container height variation ΔCHc according to the second interaction gesture MVc. The resized container 310d encloses the updated text block 300d displayed according to the fourth updated typography, including the second next interline ratio and the fourth next font size, as determined by the present system and method and described thereover.

The third updated typography is defined according to the present system and method by: the same font type, a third updated font size of 16° pt determined following the third interaction gesture MVc and the same first updated interline ratio of 1.7 determined following the first interaction gesture MVa.

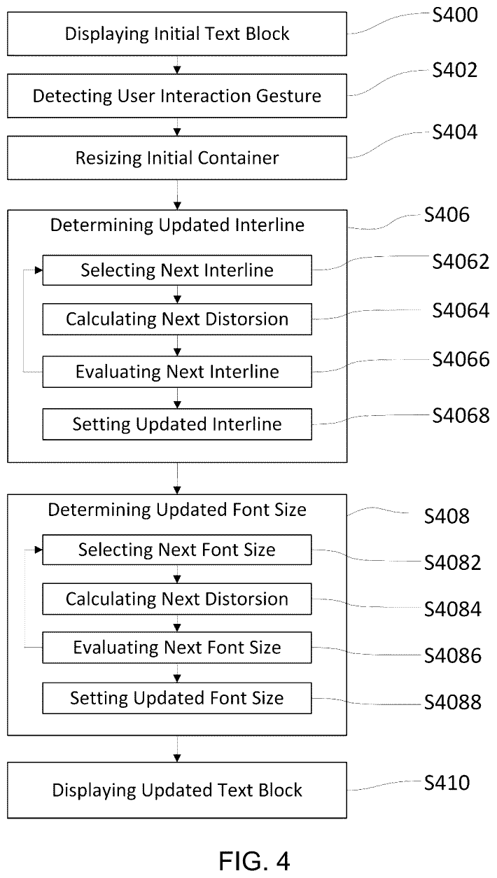

A method implemented by the computing device DV (as described earlier with reference notably to FIG. 1-3) for rescaling an initial text block is now described with reference to FIG. 4, in accordance with a particular embodiment of the present invention. More specifically, the computing device DV implements this method by executing the application 12 stored in the memory 7.

As already described above, the initial text block contains text arranged in multiple lines according to an initial font size and an initial interline ratio (or more generally according to an initial typography defined by at the initial font size and initial interline ratio). The text of the initial text block is thus distributed in a plurality of text lines.

In a particular example, the multiple lines of the text are arranged according to a same initial interline distance between each pair of consecutive lines. The initial interline ratio may be determined as a function of the initial font size and the initial interline distance.

In a displaying step S400, the computing device DV displays the initial text block on a display (including the text and the block handle). The initial text block on display is enclosed in an initial container having an initial container height. This initial container comprises a block handle for user interaction.

The text block may be displayed for instance on a constraint-free canvas that allows users to create object blocks anywhere without worrying about sizing or alignment or on a formatted document containing structured content.

In a detecting step S402, the computing device DV detects an interaction gesture over (or in interaction with) the block handle. The block handle may be bound on a side of a bounding box of the text block, defining borders of the initial container enclosing the text block. Selection of the handle, with corresponding display of the initial container, can thus be advantageously provided by the present system and method in a natural and well understood manner to users, such as by the user simply performing a single tap on the content to be resized/edited.

As is understood by those skilled in the art, as the first user gesture, the user may touch or hover over the block handle and drag/push the selected handle across the interface in a given direction, for instance in a vertical direction, namely in the upward or downward direction, so as to cause resizing of the initial text block as further explained below.

In a resizing step S404, the present system and method causes the initial container to be resized. More particularly, the computing device DV resizes the initial container height into a so-called resized container height (different from the initial container height) according to the user interaction gesture detected in S402, thereby resulting in an updated interline distance of the text. In other words, the initial interline ratio of the text is modified into a, different, updated interline distance. The resizing operation through the block handle thus causes the selected container height to be modified by a container height variation according to the user interaction gesture. The modified container height is also referred to as a resized height. The container height variation may be positive when the resizing operation causes the initial container height to increase in height, and/or negative when the resizing operation causes the initial container height to decrease in height.

The computing device DV may spread the container height variation among a number of the text lines of an updated text block modifying the space available per line of an updated text block. Accordingly, the modified space available per line implies further determination of sensible typography of the typeset text to maintain balanced display of the text block into the resized container, as further explained below

This operation may cause further modification to the text block enclosed in the container, including modification of the initial typography of the initial text block, defined by the initial interline and the initial font size, as further explained below.

In an interline determination step S406, the computing device DV determines an updated interline ratio (or interline distance or interline spacing) of the text contained in the initial text block, that is, an updated interline ratio for an updated text block to be displayed in replacement of the initial text block. This updated interline ratio is determined (S406) based on the resized container height and the updated interline distance. In other words, the determination S406 of the updated interline ratio is performed in response to the resizing step S404.

As explained above, an interline distance also referred to as a line height may be calculated as a function of the font size times the interline ratio. Possible interline ratios may be set as predefined interline ratios in a font information 10 stored in the memory. An initial interline is resulting from the initial font size times an initial interline ratio.

An example implementation of the interline determination step S406 comprising steps S4062-S4068 is described below.

In a next interline selection step S4062, the present system and method selects a next interline ratio retrieved from the set of predefined interline factors of the font information 10. The next interline ratio is selected as the closest predefined interline ratio to a current interline ratio as defined below. A current interline distance is deducted from the current interline ratios as factors of the initial font size.

The next interline ratio is incremented when the container height is increased and the container height variation is positive, or the next interline ratio is decremented when the container height is decreased, and the container height variation is negative.

The next interline ratio allows to calculate a next interline distance as a result of the initial font size times the next interline ratio. The next interline defines a next text block as a possible next typography for the resized container.

At a first iteration of the next interline selection step, a first current interline ratio is set as the initial interline ratio and a first next interline is selected from the set of predefined interline factors of the font information 10.

Depending on the outcome of an interline evaluating step S4066 explained below, at following iterations of the next interline selection step, following current interline ratios are set as the next interline ratios and following next interline ratios are incremented or decremented depending on the container height variation.

In a next interline distortion calculation S4064, the present system and method determines a next number of lines of a next text block and calculate a next interline distortion by dividing the resized container height by the next number of lines.

In the interline evaluating step S4066, the selected next interline is compared with the calculated next interline distortion to assess if the next interline fits into the next interline distortion.

When the next interline is lower than the next interline distortion, it indicates that the next interline ratio is a possible updated interline ratio. Therefore, at least another iteration of the next interline selection step S4062, the next interline distortion calculation S4064, the interline evaluating step S4066 are performed.

When the next interline distance is higher than the next interline distortion, it indicates that the next interline distance does not allow the next text block to fit into the resized container. Therefore, the next interline ratio is excluded as a possible interline ratio to update the initial text block typography and an updated interline ratio is set.

In an updated interline setting step S4068, the present system and method sets the updated interline ratio as (i) the current interline ratio when the next interline distance is higher than the next interline distortion; (ii) the next interline ratio when the next interline distance is lower than the next interline distortion and the next interline ratio is the last item of the predefined interline ratios. In this last case, the updated interline ratio is either the highest possible interline ratio when the next interline ratio is incremented or the lowest possible interline ratio when the next interline ratio is decremented. Such updated interline ratios may not fulfill acceptable typographies of the typeset text for improved readability of the text block enclosed in the resized container. For example, although the interline ratio is the smallest interline ratio available, the initial font size may not fit in the resized container and the modified space available per line. In another example, although the interline ratio is the highest interline ratio available, the resized container and the modified space available per line may still leave some space per line which does not comply with improved readability of the typography.

The present system and method is further pursuing an optimized updated typography by determining an updated font size.

In a font size determination step S408 (FIG. 4), the computing device DV determines an updated font size of the text contained in the initial text block, that is, an updated font size for the updated text block. This updated font size is determined based on the updated interline ratio determined in S406 and the resized container height. In other words, the determination S408 of the updated font size is performed in response to the determining step S406.

An example implementation of the font size determination step S408 comprising steps S4082-S4088 is described below.

In a next font size selecting step S4082, the computing device DV selects a next font size. The next font size is selected from a set of predefined font sizes of the font information 10. The next font size is the closest predefined font size to a current font size.

The next font size is incremented when the container height has been increased and the container height variation is positive, or the next font size is decremented when the container height has been decreased and the container height variation is negative.

At a first iteration of the next font size selecting step S4082, a first current font size is set as the initial font size and a first next font size is selected from the set of predefined interline factors of the font information 10.

Depending on the outcome of a font size evaluating step S4086 explained below, following iterations of the next font size selection step S4082 set following current font sizes as the next font sizes and following next font sizes are incremented or decremented depending on the container height variation.

In a next interline distortion calculation step S4084, the present system and method determines a next number of lines of the next text block and calculates the next interline distortion by dividing the resized container height by the next number of lines. In the font size evaluating step S4086, the next interline distance deduced from the selected next font size is compared with the calculated next interline distortion to assess if the next font size fits into the resized container.

When the next interline distance is lower than the next interline distortion, it indicates that the next font size is a possible updated font size. Therefore, at least another iteration of the next font size selection step S4082 is performed.

When the next interline distance is higher than the next interline distortion, it indicates that the next font size does not allow the next text block to fit into the resized container. Therefore, the next font size is excluded as a possible font size to update the initial text block typography and no further iteration is performed.

In an updated font size setting step S4088, the present system and method sets the updated font size as the current font size of a last iteration of the font size evaluating step S4086.

In another embodiment, following the determination of an updated font size, the present method is implementing the determination of the updated interline ratio again. The updated font size may allow for another updated interline ratio since an iteration of the next font size may be lowering the next interline distance as shown in the example of Table 1.

The method implements the determining of the updated interline S406 again, by selecting the next interline as a lowest predetermined interline ratio, when the container height has been increased, or a highest predetermined interline ratio, when the container height has been decreased.

The updated interline ratio is redetermined according to the above described interline ratio determining stages S4062, S4064, S4066 and S4068 for determination of another combination of the updated font size with another updated interline ratio as another optimized typography.

The updated text block is defined by the updated interline ratio and the updated font size. The updated text block is determined by the present system and method for optimizing the space of the resized container.

Further, in an updated text block displaying step S410 (FIG. 4), the computing device DV displays the updated text block on the display. The updated text block on display is enclosed in the resized container having the resized container height, said updated text block including the text as the initial text block but arranged according the updated interline ratio (determined in S406) and the updated font size (determined in S408). In a particular example, at least one of the updated interline ratio and updated font size (or both) are different from the initial interline ratio and initial font size of the initial text block.

In another embodiment, the resizing operation of the step S404 (FIG. 4) causes the selected container height to be modified whereas the resized container width is unchanged and equals an initial container width of the initial container. Therefore, according to the updated typography of the updated text block, the text of the updated text block may be reflowed over the updated number of lines within the resized container having the resized container height, so that the layout appears to be preserved, e.g., paragraphs are retained.

Text reflow designates a process by which text is moved to fit to a particular display area (e.g. page, screen, window), here the resized container. Text reflow is well known to the skilled person as it allows to improve readability and thus facilitates comprehension for a reader.

In another embodiment, the resizing operation of the step S404 causes the selected container height and the resized container width to be modified. The resized container width is adjusted to include the same number of lines as the initial text block. Therefore, following to updated typography of the updated text block, the text of the updated text block is reflowed over the initial number of lines within the resized container, so that the layout appears to be preserved, e.g., paragraphs are retained.

In another embodiment, the text of the initial text block comprises typeset text. Typeset text may be received as typeset ink using keys of the keyboard or a typing panel of the input area.

On another hand, the typeset text may arise from recognition, by the handwriting recognition system, of a handwriting input using a handwriting panel and/or a multi-modal panel of the input area.

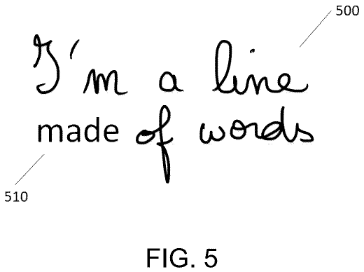

In another embodiment, the text of the initial text block comprises handwriting text. The text in the initial text block processed according to the present invention can mix both types of content, i.e. handwriting and typesetted (or typeset) text as shown in FIG. 5 by way of an example, wherein the text block includes handwritten text (or handwritten text) 500 and typeset text 510. The handwriting text 500 of mixed-type text block can be rescaled according to the rescaling method of the invention (in response to the resizing the initial container height) in an analogous manner to what is described in the present disclosure with respect to rescaling of typeset text.

1. A computer implemented method for rescaling an initial text block to maintain readability, said initial text block containing text arranged in multiple lines, having a same interline distance between any consecutive lines, according to an initial font size and an initial interline ratio, said initial interline ratio determined as a function of the initial font size and the interline distance, said method comprising:
a. displaying, in a display area, the initial text block enclosed in an initial container having an initial container height, said initial container including a block handle;
b. detecting, in an input area, a user interaction gesture over the block handle;
c. resizing the initial container height into a resized container height according to the user interaction gesture, resulting in an updated interline distance;
d. determining an updated interline ratio of said text in response to said resizing;
e. determining an updated font size of said text in response to said determining of the updated interline ratio; and
f. displaying an updated text block enclosed in a resized container having the resized container height, said updated text block including said text arranged according the updated interline ratio and the updated font size.

2. A method according to claim 1, wherein determining an updated interline ratio comprises:
g. setting a current interline ratio as the initial interline ratio;
h. selecting a next interline ratio, wherein the next interline ratio is the closest one of a set of predefined interline ratios to the current interline ratio, whereby the next interline ratio is incremented when the container height increased, or decremented when the container height decreased;
i. determining a next number of lines of a next text block, wherein the next text block is defined by a next interline distance calculated based on the next interline ratio times the initial font size;
j. calculating a next distortion by dividing the resized container height by the next number of lines;
k. evaluating the next interline ratio by:
when the next interline distance is lower than the calculated distortion, setting the current interline ratio as the next interline ratio, and repeating the steps of h. to k.;
when the next interline distance is higher than the calculated distortion, setting the updated interline ratio as the current interline ratio.

3. A method according to claim 1, wherein determining an updated font size comprises:
l. setting a current font size as the initial font size;
m. selecting a next font size, wherein the next font size is the closest one of a set of predefined font size to the current font size, whereby the next font size is incremented when the container height is increased, or decremented when the container height is decreased;
n. determining the next number of lines of the next text block, wherein the next text block is defined by the next interline distance calculated based on the updated interline ratio and the next font size;
o. calculating a next distortion by dividing the resized container height by the next number of lines;
p. evaluating the next font size by:
when the next interline distance is lower than the distortion, setting the current font size as the next font size, and repeating the steps m. to p.;
when the next font size is higher than the distortion, setting the updated font size as the current font size.

4. A method according to claim 1, wherein a resized container width of the updated text block equals an initial container width of the initial container, said updated text block being reflowed within the resized container.

5. A method according to claim 1, wherein a resized container width of the updated text block is adjusted to include the same number of lines as the initial text block.

6. A method according to claim 1, wherein said text comprises typeset text.

7. A method according to claim 6, wherein said text further comprises handwriting text, wherein said handwriting text is rescaled in response to said resizing the initial container height c.

8. A computer program comprising instructions which, when executed by one or more processors, causes the one or more processors to carry out a method according to claim 1.

9. A computing device (DV) for rescaling an initial text block to maintain readability, said initial text block containing text arranged in multiple lines, having the same interline distance between any consecutive lines, according to an initial font size and an initial interline ratio, said initial interline ratio determined as a function of the initial font size and the interline distance, said computing device comprising:
a. a display area configured to display the initial text block enclosed in an initial container having an initial container height, said initial container including a block handle; and,
b. an input area configured to detect a user interaction gesture over the block handle;
C. a container resizer module configured to resize the initial container height into a resized container height according to the user interaction gesture, resulting in an updated interline distance;
d. an interline determination module configured to determine an updated interline ratio of said text in response to said the container resizer module; and
e. a font size determination module configured to determine an updated font size of said text in response to the interline determination module;
wherein the display area is further configured to display an updated text block enclosed in a resized container having the resized container height, said updated text block including said text arranged according to the updated interline ratio and the updated font size.

10. A computing device according to claim 9, wherein the interline determination module comprises:
a. a current interline establisher configured to set a current interline ratio as the initial interline ratio;
b. a next interline selector configured to select a next interline ratio, wherein the next interline ratio is the closest one of a set of predefined interline ratios to the current interline ratio, whereby the next interline ratio is incremented when the container height increased, or decremented when the container height decreased;
c. a next number of line determinator configured to determine a next number of lines of a next text block, wherein the next text block is defined by a next interline distance calculated based on the next interline ratio times the initial font size;
d. a next distortion calculator configured to calculate a next distortion by dividing the resized container height by the next number of lines;
e. a next interline evaluator configured to evaluate the next interline ratio by:
when the next interline distance is lower than the calculated distortion, setting the current interline ratio as the next interline ratio, and causing to repeat the steps of selecting of the next interline ratio, determining of the next number of lines, calculating of the next distortion, and evaluating of the next interline ratio;
when the next interline distance is higher than the calculated distortion, setting the updated interline ratio as the current interline ratio.

11. A computing device according to claim 9, wherein the font size determination module comprises:
a. a current font size establisher configured to set a current font size as the initial font size;
b. a next font size selector configured to select a next font size, wherein the next font size is the closest one of a set of predefined font size to the current font size, whereby the next font size is incremented when the container height is increased, or decremented when the container height is decreased;
c. a next number of lines determinator configured to determining the next number of lines of the next text block, wherein the next text block is defined by the next interline distance calculated based on the updated interline ratio and the next font size;
d. a next distortion calculator configured to calculate a next distortion by dividing the resized container height by the next number of lines;
e. a next font size evaluator configured to evaluate the next font size by:
when the next interline distance is lower than the distortion, setting the current font size as the next font size, and causing to repeat the steps of selecting of a next font size, determining of a next number of lines, calculating of a next distortion, and evaluating of the next font size;
when the next font size is higher than the distortion, setting the updated font size as the current font size.
